(19) United States
(12) Patent Application Publication
(10) Pub. No.: US 2025/0267696 A1
(43) Pub. Date: Aug. 21, 2025

(54) Methods and Apparatuses for Mapping a Service Request to Radio Resources and Transport Resources in a Network

(71) Applicant: Telefonaktiebolaget LM Ericsson (publ), Stockholm (SE)

(72) Inventors: Paola Iovanna, Pisa (IT); Filippo Ponzini, Pisa (IT); Giulio Bottari, Pisa (IT)

(21) Appl. No.: 19/104,822

(22) PCT Filed: Aug. 30, 2022
(86) PCT No.: PCT/EP2022/074106

§ 371 Date: Feb. 19, 2025

(51) Int. Cl. H04W 72/543

(52) U.S. Cl. CPC H04W 72/543

(57) ABSTRACT

Embodiments described herein relate to methods and apparatuses for mapping a service request to radio resources in a deployment area. A method in a resource orchestrator comprises receiving a request from a service orchestrator to provide radio resources in a first network slice to meet a first Quality of Service requirement for a first service; identifying first radio resources in the first network slice for allocation to the first service; and responsive to obtaining an indication that first transport resources can be provided such that collectively the first radio resources and the first transport resources meet the first QoS requirement for the first service, initiating allocation of the first radio resources and the first transport resources to the first service.

### TECHNICAL FIELD

Embodiments described herein relate to methods and apparatuses for mapping a service request to radio resources and transport resources in a network. In particular, embodiments described herein ensure that collectively the radio resources and transport resources provided for a first service meet a QoS requirement associated with the first service.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

5G network slicing is a functionality, embedded in 5G Radio Access Networks (RANs), which enables the multiplexing of virtualized and independent logical networks on a shared physical infrastructure. Each network slice is an isolated End-to-End (E2E) network tailored to fulfil diverse requirements requested by a particular application. A network slice may, for example, ensure Ultra-Reliable Low-Latency Communication (URLLC) to support a vertical service related to robotics.

The presence of network slices may be considered not optional in 5G. For example, there may always be at least one default network slice associated with each User Equipment (UE). Each network slice operates on specific Tracking Areas (TA), served by a set of base stations (e.g. gNBs) and by an Access and Mobility management Function (AMF). This means that each network function may be “placed” accordingly with the area and the service covered by each network slice.

Network slicing is becoming an increasingly important functionality for current and future, service-oriented, cellular networks as it is a cost-effective technique to share the physical infrastructure among heterogeneous vertical actors. In addition, network slices may be created, changed, and removed by management functions, so they are fully managed and programmable resource.

FIG. 1 illustrates a simplified example of an end-to-end (E2E) network slicing architecture which spans from the RAN side 101 of a network 100 to the core side 102 of a network, crossing a transport segment 103.

With the scope to define the awaited Quality of Service (QoS) established in a Service Level Agreement (SLA) at the network slice level (indicated with “QoS X” in FIG. 1), 3GPP has introduced a parameter named 5G QoS Identifier (5QI), used to identify a specific QoS forwarding behavior for a 5G QoS Flow (equivalent to the QCI in LTE). Standardized 5QI values are specified for services that are assumed to be frequently used in 5G networks and thus benefit from optimized signaling by using standardized QoS characteristics.

3GPP provides the 5G QoS characteristics associated with the 5QIs and specifies the packet forwarding treatment that a QoS Flow receives E2E, from the UE up to the User Plane Function (UPF) and back to the UE. The considered characteristics may comprise required resource types, for example, low latency, guaranteed bit rate, packet delay budget and packet error rate.

For example, the 5G QoS identifier 5QI #1 refers to a resource type which ensures a guaranteed bit rate with a packet delay budget of 100 ms and a maximum packet error rate of 10⁻². This performance is appropriate to support a service conveying, for example, conversational voice. 5QI #3 refers to a delay budget of 50 ms and a maximum packet error rate of 10⁻³. Such performance is suitable for various services, for example, real time gaming, vehicle-to-everything (V2X) services and plant monitoring.

FIG. 2a illustrates an example of three network slices each having the same 5QI (indicated as QoS 9) serving a 5G use case of consumer subscriptions. In this example, the three network slices have different priorities as slice A is dedicated to “gold” subscribers, slice B to “silver” subscribers, and slice C to “bronze” subscribers.

FIG. 2b illustrates an example in which the 5QI concept is coupled with the future Radio Resource Partitioning (RRP) technique. RRP provides isolation and secure resources in high load conditions. In RRP high-priority flows in one network slice cannot starve lower-priority flows in other network slices under resource contention. In the example illustrated in FIG. 2b, different 5QIs are present in a single network slice (e.g., QoS 1 and QoS 2 in Slice Aa) and among the different network slices.

As illustrated by FIGS. 2a and 2b, different methods for mapping QoS requirements into the network slices are admitted. As QoS settings work “orthogonal” to the network slicing and then such mapping is not automated: it is based on manual configuration.

In may be required that traffic from a single network slice, or from a group of network slices, is mapped into transport resources that match the required Service Level Agreement (SLA) for the network slice or group of network slices. This requirement may be ensured in two different ways:
1) By over-dimensioning of the transport layer. In this option, the allocation of transport resources may be made statically, based on a peak of expected radio needs. The transport layer is “locally separated” by the radio layer. With this approach, the SLA of transport services should “match” the required SLA for the E2E network slice or group of network slices in the radio layer. This approach might not always be feasible or economically justifiable. Dedicated transport may also be required when latency is an issue or when observability per network slice, in transport, is required. Moreover, the evolution and capacity upscaling of a transport network is typically performed on a slower time scale (due to the extent of the investments) compared to the radio access network. Therefore, the transport network may need to be exploited more dynamically and more efficiently in order not to constitute a bottleneck for the radio access network.
2) By conferring “transport-awareness” on the radio layer. In this option, traffic flows for an individual or a group of network slices, having heterogeneous SLA needs, are mapped into the most appropriate transport services in a shared (not dedicated) transport network. This mapping into transport services may be performed based on Virtual Local Area Network Identifier (VLAN ID), destination IP address, or physical port from the RAN node (such as baseband node).

To enforce a “transport-awareness” approach according to the second option mentioned above, an E2E orchestrator may assume responsibility for the overall E2E deployment across the 5G network, including the transport segment, working with the Virtual Network Functions Manager (VNFM), the Network Management System (NMS), the element manager system (EMS), and controllers in the different domains (radio, transport, and cloud).

FIG. 3 illustrates a reference architecture for orchestration and Network Functions Virtualization (NFV) management defined European Telecommunications Standards Institute (ETSI) Management and Orchestration (MANO).

The NFV Orchestrator (NFVO) 301 can trigger allocation and management of radio, transport, and cloud resources. Each of these technology domains may be managed by an appropriate software component, generally referred as a Virtual Infrastructure Manager (VIM) 302 and 303, for the radio and cloud domains, and a Wide-area-network Infrastructure Manager (WIM) 304, for the transport domain.

In the NFV framework, a virtualized Network Service (NS) is created that combines the individual Virtual Network Functions (VNF). For this purpose, it may be necessary to specify the Virtual Network Function (VNF) components that form the network service and their placement in the NFV infrastructure. One of the main challenges that this technology faces is the optimization of resource placement in the underlaying network infrastructure. Within the NFV framework, a physical network node which has not undergone virtualization is indicated with the term Physical Network Function (PNF). Both PNFs and VNF may be used to form an overall NS.

A Network Slice Management (NSM) function 305 oversees the lifecycle management of network slice instances. To perform this function, the NSM 305 is interfaced with the NFVO 301. In this respect, 3GPP is linking to ETSI MANO architecture for supporting network slicing in 5G. The NSM 305 selects the 5QI of the network slice(s) according to requirements expressed by service requesters (e.g. vertical actors) and associates the ETSI MANO network services to the network slice(s). This association is established and configured according to policies defined by the operator/provider.

Significant focus has been dedicated to the importance of improving radio performances in the transition between 4G and 5G. The support of extreme performance is planned in the current definition of 6G features. These challenging goals have been and will be achieved by dramatically improving the capabilities of the radio access and core segments.

In parallel, there has also been significant interest in supporting radio performances in the transport segment.

### SUMMARY

According to some embodiments there is provided a method performed by a resource orchestrator for mapping a service request to radio resources in a deployment area. The method comprises receiving a request from a service orchestrator to provide radio resources in a first network slice to meet a first Quality of Service requirement for a first service; identifying first radio resources in the first network slice for allocation to the first service; and responsive to obtaining an indication that first transport resources can be provided such that collectively the first radio resources and the first transport resources meet the first QoS requirement for the first service, initiating allocation of the first radio resources and the first transport resources to the first service.

According to some embodiments there is provided a method performed by a resource orchestrator for mapping a service request to transport resources. The method comprises obtaining an indication that first radio resources for allocation to a first service have been identified; determining whether first transport resources can be provided such that collectively the first radio resources and the first transport resources meet a first QoS requirement for the first service; and responsive to determining that first transport resources in the deployment area can be provided such that collectively the first radio resources and the first transport resources meet the first QoS requirement for the first service, initiating allocation of the first radio resources and the first transport resources to the first service.

According to some embodiments there is provided a method performed by a service orchestrator for mapping a service request to radio resources in a deployment area. The method comprises transmitting a request to a resource orchestrator to provide radio resources and transport resources to satisfy a first quality of service, QoS, requirement in a first network slice for a first service; and responsive to the resource orchestrator being unable to allocate radio resources and transport resources to the first service that collectively meet the first QoS requirement, receiving a request to renegotiate the first QoS requirement of the first service with a service requester that requested the first service.

According to some embodiments there is provided a resource orchestrator for mapping a service request to radio resources in a deployment area. The resource orchestrator comprises processing circuitry configured to cause the resource orchestrator to: receive a request from a service orchestrator to provide radio resources in a first network slice to meet a first Quality of Service requirement for a first service; identify first radio resources in the first network slice for allocation to the first service; and responsive to obtaining an indication that first transport resources can be provided such that collectively the first radio resources and the first transport resources meet the first QoS requirement for the first service, initiate allocation of the first radio resources and the first transport resources to the first service.

According to some embodiments there is provided a resource orchestrator for mapping a service request to transport resources. The resource orchestrator comprises processing circuitry configured to cause the resource orchestrator to: obtain an indication that first radio resources for allocation to a first service have been identified; determine whether first transport resources can be provided such that collectively the first radio resources and the first transport resources meet a first QoS requirement for the first service; and responsive to determining that first transport resources in the deployment area can be provided such that collectively the first radio resources and the first transport resources meet the first QoS requirement for the first service, initiate allocation of the first radio resources and the first transport resources to the first service.

According to some embodiments there is provided a resource orchestrator for mapping a service request to transport resources. The resource orchestrator comprises processing circuitry configured to cause the resource orchestrator to: obtain an indication that first radio resources for allocation to a first service have been identified; determine whether first transport resources can be provided such that collectively the first radio resources and the first transport resources meet a first QoS requirement for the first service; and responsive to determining that first transport resources in the deployment area can be provided such that collectively the first radio resources and the first transport resources meet the first QoS requirement for the first service, initiate allocation of the first radio resources and the first transport resources to the first service.

According to some embodiments there is provided a service orchestrator for mapping a service request to radio resources in a deployment area. The service orchestrator comprises processing circuitry configured to cause the service orchestrator to: transmit a request to a resource orchestrator to provide radio resources and transport resources to satisfy a first quality of service, QoS, requirement in a first network slice for a first service; and responsive to the resource orchestrator being unable to allocate radio resources and transport resources to the first service that collectively meet the first QoS requirement, receive a request to renegotiate the first QoS requirement of the first service with a service requester that requested the first service.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a simplified example of an end-to-end (E2E) network slicing;

FIG. 2a illustrates an example of three network slices each having the same 5QI (indicated as QoS 9) serving a 5G use case of consumer subscriptions;

FIG. 2b illustrates an example in which the 5QI concept is coupled with the future Radio Resource Partitioning (RRP) technique;

FIG. 3 illustrates a reference architecture for orchestration and Network Functions Virtualization (NFV) management defined European Telecommunications Standards Institute (ETSI) Management and Orchestration (MANO);

FIG. 4 illustrates an extended version of the ETSI MANO architecture illustrated in FIG. 3 which utilizes an abstraction technique;

FIG. 5 illustrates a method performed by a resource orchestrator for mapping a service request to radio resources in a deployment area;

FIG. 6 illustrates a method performed by a resource orchestrator for mapping a service request to transport resources in a deployment area;

FIG. 7 illustrates a method performed by a service orchestrator for mapping a service request to radio resources in a deployment area;

FIG. 8 illustrates an example implementation of the FIGS. 5, 6 and 7;

FIG. 9 illustrates a resource orchestrator 900 comprising processing circuitry (or logic);

FIG. 10 is a block diagram illustrating an resource orchestrator 1000 according to some embodiments;

FIG. 11 illustrates an resource orchestrator 1100 comprising processing circuitry (or logic);

FIG. 12 is a block diagram illustrating a resource orchestrator 1200 according to some embodiments;

FIG. 13 illustrates a service orchestrator 1300 comprising processing circuitry (or logic);

FIG. 14 is a block diagram illustrating a service orchestrator 1400 according to some embodiments.

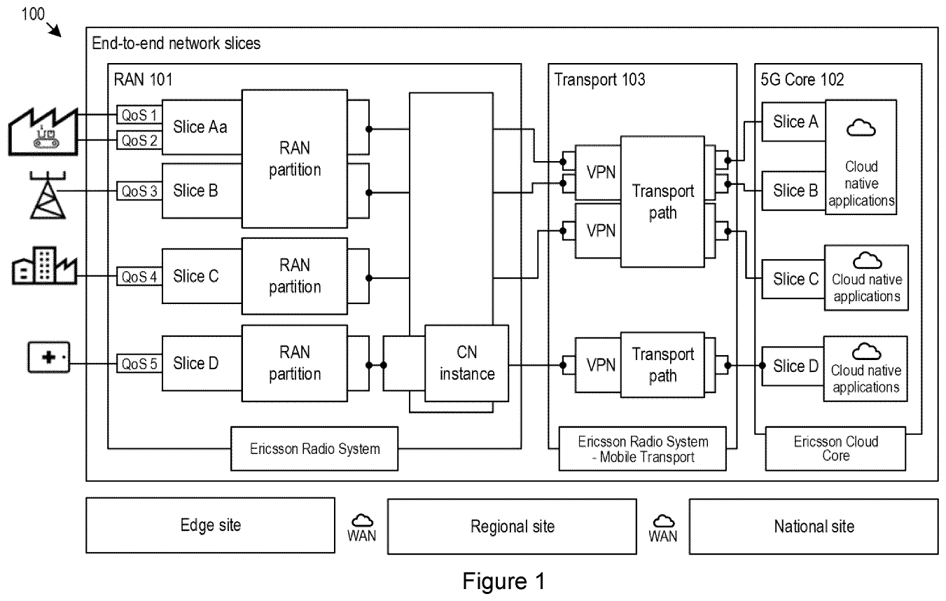

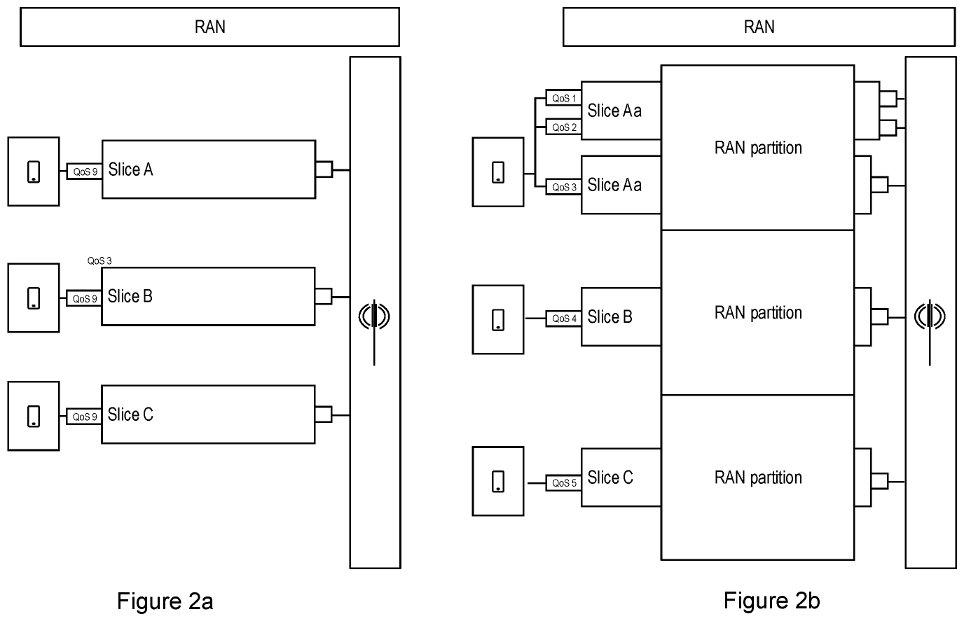

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

As the target performance of both the radio and transport domains increases the level of challenge, a concurrent management of the radio and transport domains becomes desirable because, in effect, the E2E QoS is contributed to by the “combination” of the QoS guaranteed in the radio domain with the QoS guaranteed in the transport domain. In existing art this combination is not operated or managed automatically, making it difficult to configure the radio domain and transport domain to operate at the increasing target performance levels.

One key issue in the collaborative management of the radio domain and the transport domain is the mentioned placement of the VNFs/PNFs. More specifically, the placement of the VNF/PNF is currently performed without any indication of the QoS that would be provided by the transport layer. For example, a VNF may be connected through a simple point-to-point transport link or, alternatively, through a meshed geographical transport network, regardless of the QoS provided by these different links. However, these two options imply very different latency values or different availability in operating the VNF. It would be beneficial to take this difference into account when placing VNFs/PNFs in order to meet overall QoS requirements for the overall service.

In the background section above, two ways of ensuring the requirement that traffic from a single network slice, or from a group of network slices, is mapped into transport resources that match the required Service Level Agreement (SLA) are discussed. It will be appreciated that embodiments described herein focus on the second way discussed, that is the case in which a slice or a group of slices may have several traffic flows with individual requirements on transport characteristics and the transport service is not over-dimensioned.

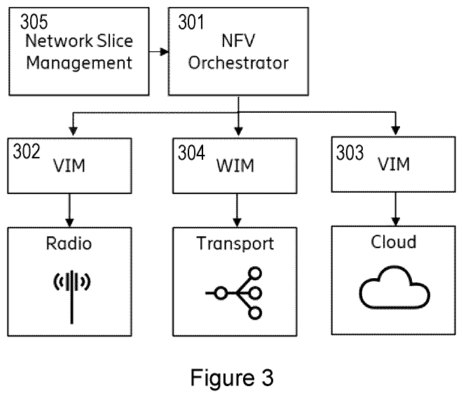

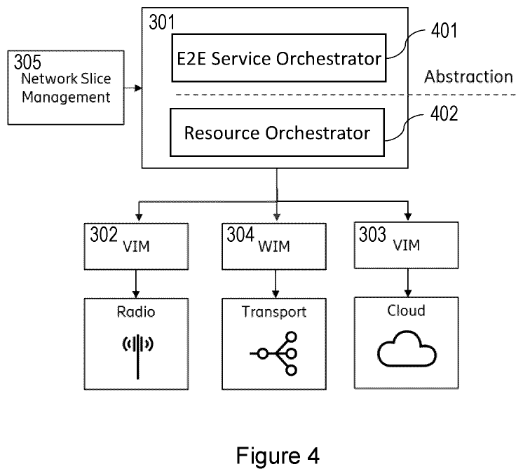

FIG. 4 illustrates an extended version of the ETSI MANO architecture illustrated in FIG. 3 which utilizes an abstraction technique. Elements of FIG. 4 that correspond to those illustrated in FIG. 3 are given the same reference numbers.

With the introduction of the abstraction technique, the NFVO 301 may be partitioned in to two functional blocks: a resource orchestrator (RO) 401 and a service orchestrator (SO) 402.

The resource orchestrator 401 may be configured to create an abstracted view of the network resources and may trigger these network resources to satisfy the QoS requirements associated with a particular network slice. The resource orchestrator 401 may also be configured to perform E2E admission control and triggers controllers in the different domains (e.g radio and transport) for resource handling.

The service orchestrator 402 (e.g. an E2E Service Orchestrator (SO)), may be configured to place ETSI NS elements (PNF/VNF) indicated in the abstracted view generated by the RO 401 to guarantee the QoS of a network slice. The service orchestrator 402 may also be configured to request resources from the RO and, if not available, may negotiate a network slice associated with lower QoS requirements the service requester.

In the abstraction technique, the corresponding service parameters of a network resource may be exposed to service orchestrator 402 while the details of the network resource itself (such as number of channels, physical details, real topology, etc.) may be hidden. The service orchestrator 402 is therefore presented with an abstracted view of the transport layer which allows for the consideration the transport capabilities as soon as the placement process starts.

Embodiments described herein focus on the interaction between the service orchestrator 402, resource orchestrator 401 (considering a QoS policy table), assuming that the abstraction of underlying resources has been already been performed using existing techniques. The policy table comprises QoS policies used to prioritize critical traffic, prevent excess bandwidth usage, and manage network bottlenecks to prevent packet drops. The policy table comprises a list of QoS policies that may be used by the resource orchestrator (or by a management system) to enforce policies according to the desired QoS levels.

For sake of simplicity, some embodiments described herein consider 5QI as the method for QoS support. However, it will be appreciated that embodiments described herein are applicable to other methods of QoS support, for example, QCI for LTE or any as of yet undefined QoS support for 5G Beyond/6G.

In particular embodiments described herein relate to a method operating in conjunction with the standard network slice provisioning in a mobile network. The method comprises a closed-loop configuration of radio and transport domains according from a service request originated by a third entity, i.e. a vertical.

The requested services are each defined over a specific “service deployment area” and as such, the method may be configured to ensure that the network functions and connectivity resources (e.g. both the radio resources and transport resources allocated to the service) are allocated with concurrent consideration of both radio and transport characteristics in order to meet QoS requirements with an efficient use of network resources.

The method also provides a feedback mechanism to a service requester (e.g. a vertical actor) if a required E2E QoS cannot be set or maintained (i.e. due to a change in the network conditions). This feedback mechanism allows for cases in which a requested service could be served with relaxed QoS requirements (instead of being rejected at all).

In embodiments described herein a service requester transmits a service request for a first service to the SO 402. The service request may indicate a first requested QoS parameter with which the first service should be provided. The first service may be associated with a deployment area. A deployment area may comprise a local indoor or outdoor geographical area.

In some embodiments, to support the requested first service, the radio network may provide a specific QoS forwarding behaviour identified by a first QoS requirement (e,g, a QoS Identifier such as QCI in LTE or 5QI in 5G). The association of the first QoS requirement with the first requested QoS parameter of the first service may be configured by a provider/operator with a specific policy. For example, the first requested QoS parameter of the first servicey may be a latency of 12 ms required by an industry to support the remote control of robots. The provider/operator may have configured a specific policy according to which the support of latencies lower than 12 ms is provided (assuming a 5G network) by a slice with a QoS identifier 5QI #82. So, the provider/operator associates the requested parameter of 12 ms to the QoS requirement of 5QI #82. A different policy could be configured, for example, to associate with 5QI #83 which similarly ensures 10 ms but has a different Maximum Data Burst Volume. The resource orchestrator 401 may then be configured to submit, to the underlying physical infrastructure, a network slice request with the characteristics associated with the selected first QoS requirement.

Embodiments described herein provide methods and apparatuses that consider, in response to the resource orchestrator's request, the QoS capabilities of both the radio resources (spectrum, RAN, Core) and the transport resources. In this way, both the radio resources and transport resources may be allocated appropriately to fit the selected first QoS requirements. The allocation of both the radio resources and the transport resources may be dynamic and automatic.

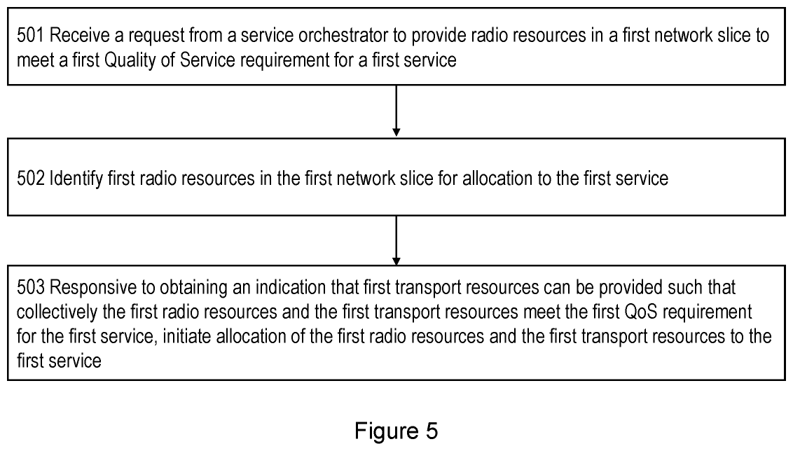

FIG. 5 illustrates a method performed by a resource orchestrator for mapping a service request to radio resources in a deployment area. In a specific example, the deployment area may comprise an industrial district is in a specific sub-urban area of 10 km², hosting many Small Medium Enterprises (SME) that need low-latency cellular coverage for industrial automation purposes.

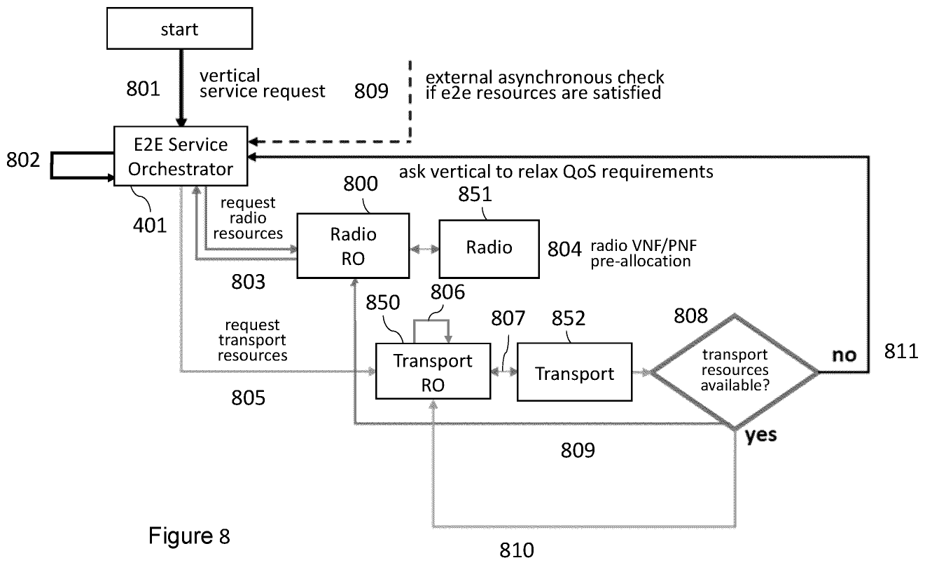

The method 500 may be performed by a resource orchestrator, which may comprise a physical or virtual node, and may be implemented in a computing device or server apparatus and/or in a virtualized environment, for example in a cloud, edge cloud or fog deployment. In some examples, the method 100 may be performed by a resource orchestrator 402 as illustrated in FIG. 4. In some examples, the method 500 may be performed by a radio resource orchestrator (e.g. radio resource orchestrator 800 as described later with reference to FIG. 8).

In step 501, the method comprises receiving a request from a service orchestrator (e.g. SO 401) to provide radio resources in a first network slice to meet a first Quality of Service requirement for a first service. For example, the first quality of service requirement may comprise a 5QI associated with the first network slice (for 5G). For the specific example mentioned above, the first network slice may be associated with 5QI #82. 5QI #82 ensures a guaranteed bit rate with a latency <10 msec and a packet error rate of 10⁻⁴.

In step 502 the method comprises identifying first radio resources in the first network slice for allocation to the first service. For example, the first radio resources may comprise or more VNFs and/or PNFs that may be used to implement the first service. In particular, the identified first radio resources may be able to implement the first service whilst meeting the first QoS requirement.

In step 503 the method comprises, responsive to obtaining an indication that first transport resources can be provided such that collectively the first radio resources and the first transport resources meet the first QoS requirement for the first service, initiating allocation of the first radio resources and the first transport resources to the first service. In other words, the method considered the collective QoS provided by both the first radio resources and the first transport resources. This may therefore avoid inadvertently provisioning a service with transport resources that may cause the overall QoS to not meet the first QoS requirement.

In some embodiments the method further comprises, responsive to first transport resources being unable to be provided such that collectively the first radio resources and the first transport resources meet the first QoS requirement for the first service, receiving a new request from the service orchestrator to provide radio resources in a second network slice (which may be the same as the first network slice) to meet a second QoS requirement for the first service, wherein the second QoS requirement is lower than the first QoS requirement. In some examples, as will be described later with reference to FIG. 8, the second QoS requirement may be negotiated with the service requester that requested the first service.

In particular, in some examples, the step of receiving the new request is performed responsive to a service requester accepting the second QoS requirement for the first service, wherein the service requester requested the first service.

However, in some examples, the new request is received before a negotiation with the service requester takes place. In these examples, the resource orchestrator first obtains an indication that second transport resources can be provided such that collectively the second radio resources and the second transport resources meet the second QoS requirement for the first service before obtaining an indication of whether the service requester accepts the second QoS requirement for the first service. In this case, responsive to the service requester accepting the second QoS requirement for the first service, initiating allocation of the of the second radio resources and the second transport resources to the first service.

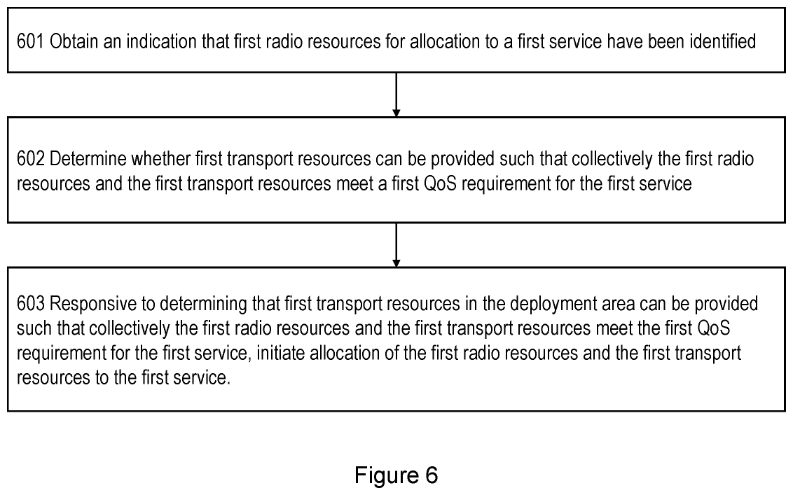

FIG. 6 illustrates a method performed by a resource orchestrator for mapping a service request to transport resources in a deployment area.

The method 600 may be performed by a resource orchestrator, which may comprise a physical or virtual node, and may be implemented in a computing device or server apparatus and/or in a virtualized environment, for example in a cloud, edge cloud or fog deployment. In some examples, the method 600 may be performed by a resource orchestrator 402 as illustrated in FIG. 4. In some examples, the resource orchestrator 402 may be configured to perform both method 500 as described with reference to FIG. 5 and method 600 as described here with reference to FIG. 6. In some examples however, the method 600 may be performed by a transport resource orchestrator (e.g. transport resource orchestrator 850 as illustrated with reference to FIG. 8). In other words, in some examples, the methods 500 and 600 may be performed by separate nodes.

In step 601, the method comprises obtaining an indication that first radio resources for allocation to a first service have been identified. The radio resources may be identified by the resource orchestrator (or a radio resource orchestrator) as described with reference to FIG. 5.

In step 602, the method comprises determining whether first transport resources can be provided such that collectively the first radio resources and the first transport resources meet a first QoS requirement for the first service.

In some examples, the QoS experienced in the radio domain and the transport domains may be additive (e.g. for the latency experienced in both domains). In these examples, the step of determining whether first transport resources can be provided such that collectively the first radio resources and the first transport resources meet a first QoS requirement for the first service may comprise the following steps.
1) Obtaining an indication of a radio Quality of Service, QoS, expected to be provided by the first radio resources. For the specific example described above, the RO may estimate the latency experienced in the radio domain as 9 ms. This delay may also comprise a delay introduced by the VNF management.
2) Determining a required transport QoS as a difference between the radio QoS and the first QoS requirement. For example, the first QoS requirement may indicate a maximum latency of 10 msec. The required transport QoS may therefore be 10 ms−9 ms=1 ms; and
3) Determining whether the first transport resources can be provided that meet the required transport QoS. In other words, the RO may ask a controller of the transport domain to provide connectivity to the first radio resources with a residual latency budget of 1 ms.

It will be appreciated that there are several related aspects of the network service that are considered to determine the QoS, such as packet loss, bit rate, throughput, transmission delay (latency), availability, jitter, etc.

Not all of these parameters constituting the QoS are additive as described above. For example, the end-to-end “availability” is the one of the “weakest” parts of the network, for example, of the transport segment. End-to-end availability is not an additive QoS. In this example, the same QoS requirement may be applied in both the radio and transport domains. In other words, the end-to-end availability in the transport domain must match that provided in the radio domain.

In most of the cases, the transport domain is not dedicated to radio but may be shared among different access technologies (e.g. wireline access, radio access). This make the QoS setting in the two domains almost independent. It will be appreciated that QoS requirements may be guaranteed in all the crossed domains, so an issue on a specific network segment may affect the e2e QoS.

As for the “end-to-end availability” parameters of the service, this may be considered to refer to the percentage of time the service is accessible to the user in a given period, usually defined as a year. Five-nines availability, or 99.999%, may be required and this means that only 15 minutes of outage in a year for the service is acceptable. This E2E availability shall be provided by the combination of radio and transport network supporting the service. So the E2E availability of “five-nines” for the service may be translated to a similar requirement of “five-nines” for both the radio network and the transport network. If the transport network would ensure just “four-nines” then the corresponding E2E availability for the service would be degraded consequently.

In step 603 the method comprises, responsive to determining that first transport resources in the deployment area can be provided such that collectively the first radio resources and the first transport resources meet the first QoS requirement for the first service, initiating allocation of the first radio resources and the first transport resources to the first service.

In some examples, the method 600 further comprises responsive to determining that first transport resources in the deployment area cannot be provided such that collectively the first radio resources and the first transport resources meet the first QoS requirement for the first service, initiating renegotiation of QoS requirements with a service requester that requested the first service. By renegotiating the QoS requirements for the first service, the embodiments described herein may avoid the rejection of services that would otherwise have been serviceable with a lower QoS that is actually acceptable to the service requester.

In some examples, responsive to initiating renegotiation of QoS requirements with a service requester that requested the first service, the method further comprises obtaining an indication that second radio resources for allocation to the first service have been identified; and determining whether second transport resources can be provided such that collectively the second radio resources and the second transport resources meet a second QoS requirement for the first service.

In particular, in some examples, the step of obtaining an indication that the second radio resources for allocation to the first service have been identified is performed responsive to a service requester accepting the second QoS requirement for the first service, wherein the service requester requested the first service. In this case, responsive to determining that second transport resources can be provided such that collectively the second radio resources and the second transport resources meet the second QoS requirement for the first service, initiating allocation of the second radio resources and the second transport resources to the first service.

However, in some examples, the indication of whether the service requester accepts the second QoS requirement for the first service, is only obtained after determining that second transport resources can be provided such that collectively the second radio resources and the second transport resources meet the second QoS requirement for the first service. In this case, responsive to the service requester accepting the second QoS requirement for the first service, initiating allocation of the second radio resources and the second transport resources to the first service.

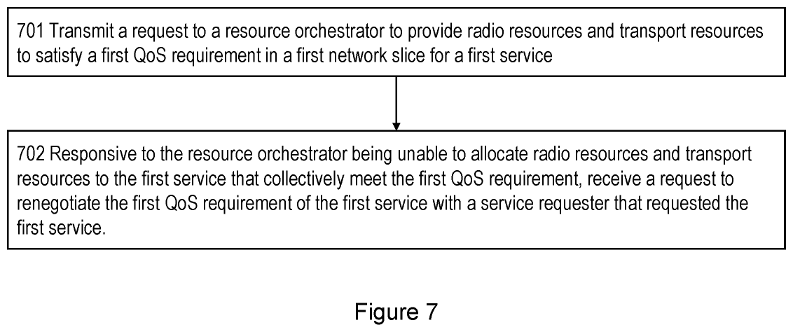

FIG. 7 illustrates a method performed by a service orchestrator for mapping a service request to radio resources in a deployment area.

The method 700 may be performed by a network node, which may comprise a physical or virtual node, and may be implemented in a computing device or server apparatus and/or in a virtualized environment, for example in a cloud, edge cloud or fog deployment. For example, the method 700 may be performed by a service orchestrator 401 as illustrated in FIG. 4.

In step 701 the method comprises transmitting a request to a resource orchestrator to provide radio resources and transport resources to satisfy a first QoS requirement in a first network slice for a first service. For example, the first QoS requirement may comprise a 5QI associated with the first network slice. The resource orchestrator may comprise the resource orchestrator 402 illustrated in FIG. 4. Step 701 may correspond to step 501 of FIG. 5. It will be appreciated that a service request for the first service may be received from a service requester, wherein the service request indicates a first requested QoS parameter for the first service. For example, the requested QoS parameter may be a maximum E2E latency of 10 ms.

Before transmitting the request in step 701, the service orchestrator may determine the first radio slice for performing the first service by selecting a first radio slice associated with first QoS requirement that can deliver the first requested QoS parameter. In the specific example mentioned above therefore, the service orchestrator may select the network slice associated with the 5QI #82 as the first network slice, as 5QI #82 ensures a guaranteed bit rate with a latency <10 msec and is therefore sufficient to serve the specific needs stipulated by the service orchestrator in the first requested QoS parameter.

It will be appreciated that in some examples a network slice may be selected that is associated with a first QoS requirement that is effectively “better” than that of the first requested QoS parameter. For example, is the first requested QoS parameter is a maximum latency of 15 ms, the 5QI #82 network slice be able to deliver a service that meets the first requested QoS parameter.

In step 702, responsive to the resource orchestrator being unable to allocate radio resources and transport resources to the first service that collectively meet the first QoS requirement, receiving a request to renegotiate the first QoS requirement of the first service with a service requester that requested the first service.

FIG. 8 illustrates an example implementation of the FIGS. 5, 6 and 7. In this example, the resource orchestrator 402 is illustrated as a radio resource orchestrator 800 and a transport resource orchestrator 850. It will however be appreciated that the functionality of the radio resource orchestrator 800 and the transport resource orchestrator 801 may be combined within the same logical node.

In step 801, the service orchestrator 401 receives a service request from a service requester (e.g. a vertical actor). The service request may indicate that a first service is to be provided in a deployment area. For example, Ultra Low Latency Communication (URLLC) connectivity is to be provided at a factory plant (indoor deployment area).

In step 802, the service orchestrator 401, in response to the service request, maps the first service to a first network slice suitable to serve the request and identifies the most appropriate first QoS requirement (e.g. a 5QI). The service orchestrator 401 has an indirect visibility of infrastructure through its abstraction.

In step 803 the service orchestrator 401 triggers the radio resource orchestrator 800 to provide radio resources (e.g., VM allocation for VNF, configuration of PNF, etc.) to satisfy the performance targets associated with the first QoS requirement (e.g. 5QI type). Step 803 comprises an example implementation of step 501 of FIG. 5.

In step 804, in the radio domain 851, the radio resource orchestrator 800 identifies the radio resources based on the first network slice according to the policy previously configured. In case RRP reservation is applied, the radio resource orchestrator 800 may also be in control for corresponding spectrum reservation. Step 804 comprises an example implementation of step 502 of FIG. 5.

In step 805, the transport resource orchestrator 850 obtains an indication that first radio resources for allocation to a first service have been identified. In some examples, the transport resource orchestrator 850 may receive this indication from the service orchestrator 401. Step 805 comprises an example implementation of step 601 of FIG. 6. In step 805 the transport resource orchestrator 850 may also obtain an indication of the first QoS requirement (e.g. the 5QI).

In step 806, the transport resource orchestrator 850 identifies transport QoS requirements (for example as described above with reference to FIG. 6). The transport resource orchestrator 850 may then, in step 807, send a request(s) to the transport domain(s) 852 for transport resources that meet the identified transport QoS requirements. If more than one transport domain 852 is involved, the transport resource orchestrator 850 may manage the corresponding controllers for each transport domain 852.

In step 808 it is determined whether first transport resources can be provided such that collectively the first radio resources and the first transport resources meet a first QoS requirement for the first service. For example, it may be determined whether first transport resources can be provided that meet the transport QoS requirements identified in step 806. If the transport domain(s) 852 can provide the first transport resources that would meet the identified first transport QoS requirements, immediately or through internal rearrangement of resources (e.g. pre-emption or rerouting for optimization) then the method passes to steps 809 and 810.

In step 809, the method comprises initiating allocation of the first radio resources to the first service. For example, step 809 may comprise triggering the radio resource orchestrator 800 to proceed to place the first radio resources (e.g. VNFs and/or PNFs) in the radio domain 851.

In step 810, the method comprises initiating allocation of the first transport resources to the first service. For example, step 810 may comprise triggering the transport resource orchestrator 852 to proceed to allocate the first transport resource in the transport domain(s) 852 to the first service.

Steps 809 and 810 are an example implementation of step 503 of FIG. 5 or step 603 of FIG. 6.

If in step 808 it is determined that the transport domain(s) 852 cannot provide first transport resources that would meet the identified first transport QoS requirements, the method passes to step 811. In step 811, the method comprises transmitting a request, to the service orchestrator 401, to renegotiate the first QoS requirement of the first service with a service requester that requested the first service.

Responsive to receiving the request to renegotiate the first QoS requirement, the service orchestrator 401 may, for example, proceed in one of two ways.
1) Determining maximum QoS available before renegotiation. In this option, the service orchestrator may first transmit a new request to the resource orchestrator to provide radio resources and transport resources to satisfy a second QoS requirement in a second network slice for a first service. Then, responsive to the resource orchestrator being able to allocate radio resources and transport resources to the first service that collectively meet the second QoS requirement, the service orchestrator may transmit a request to the service requester to determine whether the service requester will accept the second QoS requirement for the first service. It will be appreciated that the second QoS requirement is lower than the first QoS requirement.

In this first option, the service orchestrator may iteratively lower the QoS requirements in requests to the resource orchestrator until the request can be met by the radio and transport domains. At that point, the service orchestrator may transmit a renegotiation request to the service requester to check that the service requester will accept the lower QoS requirement. If the service requester will accept the lower (e.g. second) QoS requirement, the service orchestrator may initiate allocation of the radio and transport resources to the first service that meet the lower QoS requirements. If the service requester will not accept the lower QoS requirement, the first service may be rejected.
2) Receiving agreement from service requester before determining availability. In this option, the service orchestrator may first transmit a request to the service requester to determine whether the service requester will accept the second QoS requirement for the first service. It will be appreciated that the second QoS requirement is lower than the first QoS requirement. Responsive to the service requester accepting the second QoS requirement for the first service, the service orchestrator 401 may then transmit a new request to the resource orchestrator to provide radio resources and transport resources to satisfy the second QoS requirement in a second network slice for the first service.

In this option, it will be appreciated that multiple renegotiations with the service requester may occur before resources can be found that satisfy an agreed QoS requirement.

After step 811, the result of the procedure may be one of the following:
1) The first service may have been provision with radio resources and transport resources according to a third QoS requirement. For example, the third QoS requirement may comprise the first QoS requirement. In other words, the first service may have been successfully allocated resources with the initial QoS requirements. However, the third QoS requirement may in some examples comprise the second QoS requirement. In other words, the first service may only have been successfully allocated resources after renegotiation of the QoS requirements for the first service.
2) The first service may have been rejected.

Where the result of the procedure in steps 801 to 811 is as identified in 1), the radio domain may be notified with a positive acknowledge, and transport nodes may be configured to convey for example enhanced Common Public Radio Interface (eCPRI) traffic between the antenna sites and the baseband site. The service orchestrator 401 may also inform the service requester that the first service is available with the third QoS.

In step 812, the method comprises after provisioning the first service with radio resources and transport resources according to a third QoS requirement, checking whether the third QoS requirement continues to be met. For example, the check of step 812 may be performed responsive to one of: a change in radio resources in the deployment area; a change in transport resources serving the radio resources; and a change in the third QoS requirement.

Responsive to the third QoS requirement not being met, the service orchestrator 401 may transmit a request to the resource orchestrator 800 to re-allocate radio resources and transport resources to the first service.

In other words, step 812 may be considered to execute an external closed-loop automation that operates separately to steps 801 to 811 to check if the E2E resources for a particular service remain satisfied, even if changes in transport or radio resources occurs, or there is a change in the E2E QoS decided by the service orchestrator. Step 812 therefore allows for continuous resource monitoring, checking if the E2E QoS is met over time when network conditions change, with the option of a proactive negotiation of relaxed E2E QoS requirements.

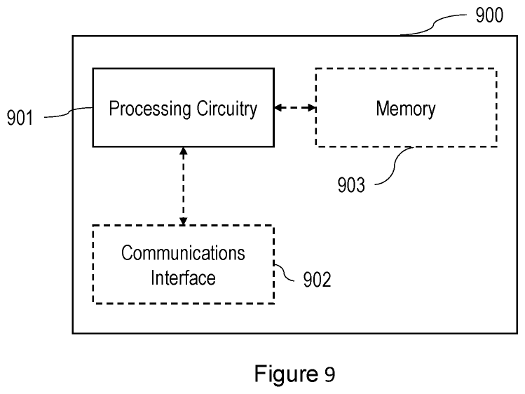

FIG. 9 illustrates a resource orchestrator 900 comprising processing circuitry (or logic) 901. The processing circuitry 901 controls the operation of the resource orchestrator 900 and can implement the method described herein in relation to an resource orchestrator 900. The processing circuitry 901 can comprise one or more processors, processing units, multi-core processors or modules that are configured or programmed to control the resource orchestrator 900 in the manner described herein. In particular implementations, the processing circuitry 901 can comprise a plurality of software and/or hardware modules that are each configured to perform, or are for performing, individual or multiple steps of the method described herein in relation to the resource orchestrator 900 or a radio resource orchestrator.

Briefly, the processing circuitry 901 of the resource orchestrator 900 is configured to: receive a request from a service orchestrator to provide radio resources in a first network slice to meet a first Quality of Service requirement for a first service; identify first radio resources in the first network slice for allocation to the first service; and responsive to obtaining an indication that first transport resources can be provided such that collectively the first radio resources and the first transport resources meet the first QoS requirement for the first service, initiate allocation of the first radio resources and the first transport resources to the first service.

In some embodiments, the resource orchestrator 900 may optionally comprise a communications interface 902. The communications interface 902 of the resource orchestrator 900 can be for use in communicating with other nodes, such as other virtual nodes. For example, the communications interface 902 of the resource orchestrator 900 can be configured to transmit to and/or receive from other nodes requests, resources, information, data, signals, or similar. The processing circuitry 901 of resource orchestrator 900 may be configured to control the communications interface 902 of the resource orchestrator 900 to transmit to and/or receive from other nodes requests, resources, information, data, signals, or similar.

Optionally, the resource orchestrator 900 may comprise a memory 903. In some embodiments, the memory 903 of the resource orchestrator 900 can be configured to store program code that can be executed by the processing circuitry 901 of the resource orchestrator 900 to perform the method described herein in relation to the resource orchestrator 900. Alternatively or in addition, the memory 903 of the resource orchestrator 900, can be configured to store any requests, resources, information, data, signals, or similar that are described herein. The processing circuitry 901 of the resource orchestrator 900 may be configured to control the memory 903 of the resource orchestrator 900 to store any requests, resources, information, data, signals, or similar that are described herein.

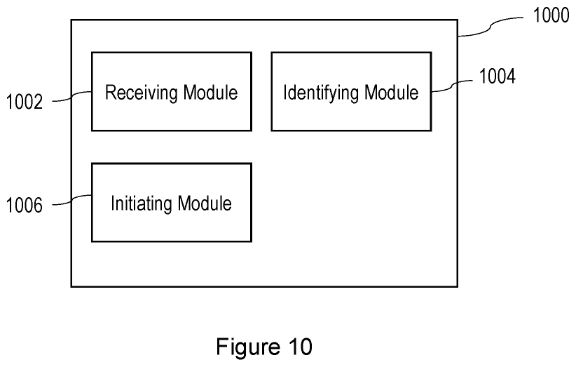

FIG. 10 is a block diagram illustrating an resource orchestrator 1000 according to some embodiments. The resource orchestrator 1000 map a service request to radio resources in a deployment area. The resource orchestrator 1000 comprises a receiving module 1002 configured to receive a request from a service orchestrator to provide radio resources in a first network slice to meet a first Quality of Service requirement for a first service. The resource orchestrator 1000 comprises a identifying module 1004 configured to identify first radio resources in the first network slice for allocation to the first service. The resource orchestrator 1000 comprises an initiating module 1006 configured to responsive to obtaining an indication that first transport resources can be provided such that collectively the first radio resources and the first transport resources meet the first QoS requirement for the first service, initiate allocation of the first radio resources and the first transport resources to the first service. The resource orchestrator 1000 may operate in the manner described herein in respect of a resource orchestrator or a radio resource orchestrator.

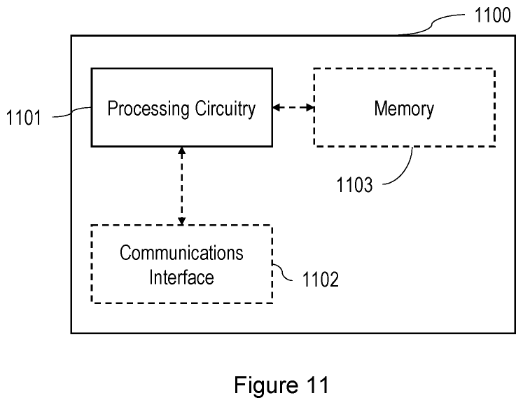

FIG. 11 illustrates an resource orchestrator 1100 comprising processing circuitry (or logic) 1101. The processing circuitry 1101 controls the operation of the resource orchestrator 1100 and can implement the method described herein in relation to an resource orchestrator 1100. The processing circuitry 1101 can comprise one or more processors, processing units, multi-core processors or modules that are configured or programmed to control the resource orchestrator 1100 in the manner described herein. In particular implementations, the processing circuitry 1101 can comprise a plurality of software and/or hardware modules that are each configured to perform, or are for performing, individual or multiple steps of the method described herein in relation to the resource orchestrator 1100 or a transport resource orchestrator.

Briefly, the processing circuitry 1101 of the resource orchestrator 1100 is configured to: obtain an indication that first radio resources for allocation to a first service have been identified; determine whether first transport resources can be provided such that collectively the first radio resources and the first transport resources meet a first QoS requirement for the first service; and responsive to determining that first transport resources in the deployment area can be provided such that collectively the first radio resources and the first transport resources meet the first QoS requirement for the first service, initiate allocation of the first radio resources and the first transport resources to the first service.

In some embodiments, the resource orchestrator 1100 may optionally comprise a communications interface 1102. The communications interface 1102 of the resource orchestrator 1100 can be for use in communicating with other nodes, such as other virtual nodes. For example, the communications interface 1102 of the resource orchestrator 1100 can be configured to transmit to and/or receive from other nodes requests, resources, information, data, signals, or similar. The processing circuitry 1101 of resource orchestrator 1100 may be configured to control the communications interface 1102 of the resource orchestrator 1100 to transmit to and/or receive from other nodes requests, resources, information, data, signals, or similar.

Optionally, the resource orchestrator 1100 may comprise a memory 1103. In some embodiments, the memory 1103 of the resource orchestrator 1100 can be configured to store program code that can be executed by the processing circuitry 1101 of the resource orchestrator 1100 to perform the method described herein in relation to the resource orchestrator 1100. Alternatively or in addition, the memory 1103 of the resource orchestrator 1100, can be configured to store any requests, resources, information, data, signals, or similar that are described herein. The processing circuitry 1101 of the resource orchestrator 1100 may be configured to control the memory 1103 of the resource orchestrator 1100 to store any requests, resources, information, data, signals, or similar that are described herein.

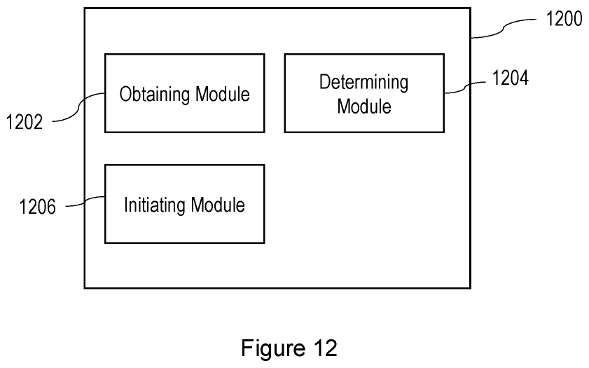

FIG. 12 is a block diagram illustrating a resource orchestrator 1200 according to some embodiments. The resource orchestrator 1200 can map a service request to transport resources. The resource orchestrator 1200 comprises an obtaining module 1202 configured to obtain an indication that first radio resources for allocation to a first service have been identified. The resource orchestrator 1200 comprises a determining module 1204 configured to determine whether first transport resources can be provided such that collectively the first radio resources and the first transport resources meet a first QoS requirement for the first service. The resource orchestrating comprises an initiating module 1206 configured to responsive to determining that first transport resources in the deployment area can be provided such that collectively the first radio resources and the first transport resources meet the first QoS requirement for the first service, initiate allocation of the first radio resources and the first transport resources to the first service. The resource orchestrator 1200 may operate in the manner described herein in respect of a resource orchestrator or a transport resource orchestrator.

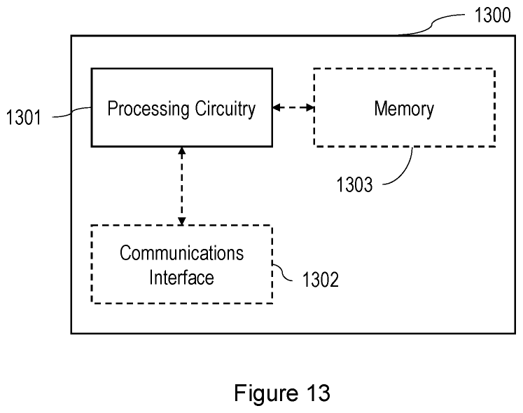

FIG. 13 illustrates a service orchestrator 1300 comprising processing circuitry (or logic) 1301. The processing circuitry 1301 controls the operation of the service orchestrator 1300 and can implement the method described herein in relation to an service orchestrator 1300. The processing circuitry 1301 can comprise one or more processors, processing units, multi-core processors or modules that are configured or programmed to control the service orchestrator 1300 in the manner described herein. In particular implementations, the processing circuitry 1301 can comprise a plurality of software and/or hardware modules that are each configured to perform, or are for performing, individual or multiple steps of the method described herein in relation to the service orchestrator 1300.

Briefly, the processing circuitry 1301 of the service orchestrator 1300 is configured to: receive a request from a service orchestrator to provide radio resources in a first network slice to meet a first Quality of Service requirement for a first service; identify first radio resources in the first network slice for allocation to the first service; and responsive to obtaining an indication that first transport resources can be provided such that collectively the first radio resources and the first transport resources meet the first QoS requirement for the first service, initiate allocation of the first radio resources and the first transport resources to the first service.

In some embodiments, the service orchestrator 1300 may optionally comprise a communications interface 1302. The communications interface 1302 of the service orchestrator 1300 can be for use in communicating with other nodes, such as other virtual nodes. For example, the communications interface 1302 of the service orchestrator 1300 can be configured to transmit to and/or receive from other nodes requests, resources, information, data, signals, or similar. The processing circuitry 1301 of service orchestrator 1300 may be configured to control the communications interface 1302 of the service orchestrator 1300 to transmit to and/or receive from other nodes requests, resources, information, data, signals, or similar.

Optionally, the service orchestrator 1300 may comprise a memory 1303. In some embodiments, the memory 1303 of the service orchestrator 1300 can be configured to store program code that can be executed by the processing circuitry 1301 of the service orchestrator 1300 to perform the method described herein in relation to the service orchestrator 1300. Alternatively or in addition, the memory 1303 of the service orchestrator 1300, can be configured to store any requests, resources, information, data, signals, or similar that are described herein. The processing circuitry 1301 of the service orchestrator 1300 may be configured to control the memory 1303 of the service orchestrator 1300 to store any requests, resources, information, data, signals, or similar that are described herein.

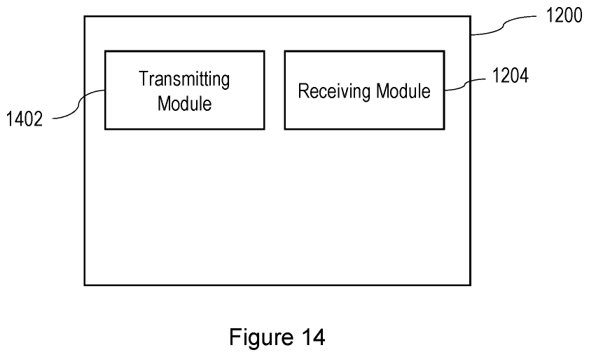

FIG. 14 is a block diagram illustrating a service orchestrator 1400 according to some embodiments. The service orchestrator 1400 can map a service request to radio resources in a deployment area. The service orchestrator 1400 comprises a transmitting module 1402 configured to transmit a request to a resource orchestrator to provide radio resources and transport resources to satisfy a first quality of service, QoS, requirement in a first network slice for a first service. The service orchestrator 1400 comprises a receiving module 1404 configured to, responsive to the resource orchestrator being unable to allocate radio resources and transport resources to the first service that collectively meet the first QoS requirement, receive a request to renegotiate the first QoS requirement of the first service with a service requester that requested the first service. The service orchestrator 1400 may operate in the manner described herein in respect of a service orchestrator.

There is also provided a computer program comprising instructions which, when executed by processing circuitry (for example, the processing circuitry 901 of the resource orchestrator 900 described earlier or any other previously described processing circuitry), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein therefore allow for automatic slice set-up with network functions being placed accordingly to meet service requirements.

Automatic E2E QoS management is also provided, as the system is aware of transport resources between nodes, their capacity and status. Concurrent optimization of radio and transport resources is also provided.

Embodiments described herein also provide service isolation and clear demarcation points between network entities, thereby facilitating monitoring and fault/congestion management

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1-35. (canceled)

36. A method performed by a resource orchestrator for mapping a service request to radio resources in a deployment area, the method comprising:
receiving a request from a service orchestrator to provide radio resources in a first network slice to meet a first Quality of Service requirement for a first service;
identifying first radio resources in the first network slice for allocation to the first service; and
responsive to obtaining an indication that first transport resources can be provided such that collectively the first radio resources and the first transport resources meet the first QoS requirement for the first service, initiating allocation of the first radio resources and the first transport resources to the first service.

37. The method as claimed in claim 36, further comprising:
responsive to first transport resources being unable to be provided such that collectively the first radio resources and the first transport resources meet the first QoS requirement for the first service, receiving a new request from the service orchestrator to provide second radio resources in a second network slice to meet a second QoS requirement for the first service, wherein the second QoS requirement is lower than the first QoS requirement.

38. The method as claimed in claim 37, wherein the first network slice is the same as the second network slice.

39. The method as claimed in claim 37, wherein the step of receiving the new request is performed responsive to a service requester accepting the second QoS requirement for the first service, wherein the service requester requested the first service.

40. The method as claimed in claim 37, further comprising:
after obtaining an indication that second transport resources can be provided such that collectively the second radio resources and the second transport resources meet the second QoS requirement for the first service, obtaining an indication of whether the service requester accepts the second QoS requirement for the first service, wherein the service requester requested the first service.

41. The method as claimed in claim 40, further comprising:
responsive to the service requester accepting the second QoS requirement for the first service, initiating allocation of the of the second radio resources and the second transport resources to the first service.

42. A method performed by a resource orchestrator for mapping a service request to transport resources, the method comprising:
obtaining an indication that first radio resources for allocation to a first service have been identified;
determining whether first transport resources can be provided such that collectively the first radio resources and the first transport resources meet a first QoS requirement for the first service; and
responsive to determining that first transport resources in the deployment area can be provided such that collectively the first radio resources and the first transport resources meet the first QoS requirement for the first service, initiating allocation of the first radio resources and the first transport resources to the first service.

43. The method as claimed in claim 42, wherein the step of determining whether first transport resources can be provided such that collectively the first radio resources and the first transport resources meet a first QoS requirement for the first service comprises:
obtaining an indication of a radio Quality of Service, QoS, expected to be provided by the first radio resources;
determining a required transport QoS as a difference between the radio QoS and the first QoS requirement; and
determining whether the first transport resources can be provided that meet the required transport QoS.

44. The method as claimed in claim 42, further comprising responsive to determining that first transport resources in the deployment area cannot be provided such that collectively the first radio resources and the first transport resources meet the first QoS requirement for the first service, initiating renegotiation of QoS requirements with a service requester that requested the first service.

45. The method as claimed in claim 44, further comprising: responsive to initiating renegotiation of QoS requirements with a service requester that requested the first service:
obtaining an indication that second radio resources for allocation to the first service have been identified; and
determining whether second transport resources can be provided such that collectively the second radio resources and the second transport resources meet a second QoS requirement for the first service.

46. The method as claimed in claim 45, wherein the step of obtaining an indication that the second radio resources for allocation to the first service have been identified is performed responsive to a service requester accepting the second QoS requirement for the first service, wherein the service requester requested the first service.

47. The method as claimed in claim 46, further comprising:
responsive to determining that second transport resources can be provided such that collectively the second radio resources and the second transport resources meet the second QoS requirement for the first service, initiating allocation of the second radio resources and the second transport resources to the first service.

48. The method as claimed in claim 45, further comprising:
after determining that second transport resources can be provided such that collectively the second radio resources and the second transport resources meet the second QoS requirement for the first service; obtaining an indication of whether the service requester accepts the second QoS requirement for the first service,
wherein the service requester requested the first service.

49. The method as claimed in claim 48, further comprising: responsive to the service requester accepting the second QoS requirement for the first service, initiating allocation of the second radio resources and the second transport resources to the first service.

50. A method performed by a service orchestrator for mapping a service request to radio resources in a deployment area, the method comprising:
transmitting a request to a resource orchestrator to provide radio resources and transport resources to satisfy a first quality of service, QoS, requirement in a first network slice for a first service; and
responsive to the resource orchestrator being unable to allocate radio resources and transport resources to the first service that collectively meet the first QoS requirement, receiving a request to renegotiate the first QoS requirement of the first service with a service requester that requested the first service.

51. The method as claimed in claim 50, further comprising:
receiving the service request for the first service from a service requester, wherein the service request indicates a first requested QoS parameter for the first service.

52. The method as claimed in claim 51, further comprising:
determining the first radio slice for performing the first service by selecting a first radio slice associated with first QoS requirement that can deliver the first requested QoS parameter.

53. The method as claimed in claim 50, further comprising responsive to receiving the request to renegotiate the QoS requirement of the first service, transmitting a request to the service requester to determine whether the service requester will accept a second QoS requirement for the first service, where the second QoS requirement is lower than the first QoS requirement.

54. The method as claimed in claim 53, further comprising:
first transmitting a new request to the resource orchestrator to provide radio resources and transport resources to satisfy the second QoS requirement in a second network slice for a first service; and
responsive to the resource orchestrator being able to allocate radio resources and transport resources to the first service that collectively meet the second QoS requirement, transmitting the request to the service requester to determine whether the service requester will accept the second QoS requirement for the first service.

55. The method as claimed in claim 53, further comprising:
responsive to the service requester accepting the second QoS requirement for the first service, transmitting a new request to the resource orchestrator to provide radio resources and transport resources to satisfy the second QoS requirement in a second network slice for a first service.
